(19) United States
(12) Patent Application Publication
(10) Pub. No.: US 2012/0106919 A1
(43) Pub. Date: May 3, 2012

(54) MULTIMEDIA SYSTEM

(75) Inventors: Byung-youn Song, Suwon-si (KR); Nag-eui Choi, Suwon-si (KR)

(73) Assignee: Toshiba Samsung Storage Technology Korea Corporation, Suwon-si (KR)

(21) Appl. No.: 13/234,290

(22) Filed: Sep. 16, 2011

(30) Foreign Application Priority Data
Oct. 27, 2010 (KR) 10-2010-0105392
Apr. 8, 2011 (KR) 10-2011-0032429

(51) Int. Cl. H04N 5/775; H04N 5/765; H04N 5/93

(52) U.S. Cl. 386/230; 386/353; 386/231; 386/E05.07; 386/E05.028; 386/E05.002

(57) ABSTRACT

A multimedia system that includes a television (TV). The TV includes an optical disc drive (ODD) that outputs raw data obtained from a medium, such as an optical disc, through a slave interface. The TV also includes a codec that processes the raw data received from the ODD. The TV includes a master interface corresponding to the slave interface, a codec device that extracts an image signal and/or an audio signal from the raw data transmitted through the interfaces, and a multimedia output device that outputs the image signal and/or the audio signal.

### CROSS-REFERENCE TO RELATED PATENT APPLICATION

This application claims the benefit of Korean Patent Application No. 10-2010-0105392, filed on Oct. 27, 2010, in the Korean Intellectual Property Office, and Korean Patent Application No. 10-2011-0032429, filed on Apr. 8, 2011, in the Korean Intellectual Property Office, the entire disclosures of which are incorporated herein in by reference for all purposes.

### BACKGROUND

1. Field

The following description relates to a multimedia system such as an audio visual (AV) system using an optical disc drive (ODD), and additionally, to a platform-based smart television (TV) capable of controlling an ODD and processing digital data.

2. Description of the Related Art

As research has recently been conducted on a platform-based audio visual (AV) device, such as a smart television (TV), which is a high performance hardware-software device using a central processing unit (CPU) and an operating system (OS), interest in such a platform-based AV device has increased. Through research and development, a smart TV has become an interactive medium which provides sky wave broadcasting programs as well as various contents accessed through the Internet by being connected to the Internet. A typical ODD for general TVs or smart TVs which has been released or researched thus far has a structure similar to a one complete playback device that is a source for providing completely reproduced audio/image information to a TV. A conventional ODD includes a front-end that processes a radio frequency (RF) signal from an internal disc and a back-end that processes a multimedia signal such as an audio/image signal from digital raw data output from the front-end. The back-end of a conventional ODD includes a decoder chip and a peripheral circuit for separating and decoding the multimedia signal. For example, the multimedia signal could include an audio/image signal. The reproduced audio/image signal decoded by the conventional ODD is generally transmitted to a TV through a high-definition multimedia interface (e.g., HDMI) that is a digital AV output interface.

Because a smart TV uses a CPU for driving an OS for general purposes for accessing and executing web contents and various multimedia through the Internet, rather than using a digital signal processor (DSP) for performing a specific given function, a smart TV may use the benefits associated with using a CPU in order to use an ODD economically and efficiently. For example, the CPU may appropriately modify an interface structure between the smart TV and the ODD that may be additionally applied or incorporated to the smart TV.

### SUMMARY

In one general aspect, there is provided a multimedia system. The multimedia system includes an optical disc drive (ODD) that outputs digital data obtained from an optical disc, a digital signal processing device comprising a codec device that processes the digital data from the optical disc and processes a multimedia signal, and a multimedia output device that outputs the multimedia signal processed by the digital signal processing device.

The codec device may include at least one of a hardware codec and a software codec corresponding to a plurality of multimedia data standards.

The multimedia system may include an operating system (OS) device comprising an OS that provides an operating environment for the at least one codec, and a processing unit that drives the OS.

The multimedia system may include a graphical user interface by which the ODD is controlled, wherein the software codec has a structure that is capable of being updated by information provided from an external storage device.

The multimedia system may include a plurality of interface devices that transmit and receive data to and from a plurality of source devices.

At least one of the plurality of interface devices may communicate using at least one of the universal serial bus (USB), serial advanced technology attachment (SATA), flash media, Ethernet, WiFi, and Bluetooth communication standards.

The multimedia system may include a stream processor that processes a video data stream.

The video data stream may be provided through a wired device or a wireless device.

The multimedia system may include a stream processor that processes a video data stream provided through the Ethernet.

The multimedia system may include a software controller that controls the ODD, wherein the software controller is capable of being updated by information provided from an external storage device.

The software controller may include the software codec.

The multimedia system may include a virtual machine (VM) that drives a source device that operates on an OS different from the OS of the OS device.

The VM may include a Java VM or a Dalvik VM corresponding to at least one of a Java and an Android source device.

At least one codec of a plurality of codecs corresponding to the plurality of multimedia data standards may be included in the hardware codec and the remaining codecs of the plurality of codecs is included in the software codec.

A plurality of codecs corresponding to the plurality of multimedia data standards may be included in only the hardware codec.

A plurality of codecs corresponding to the plurality of multimedia data standards may be included in only the software codec.

Some or all of a plurality of codecs corresponding to the plurality of multimedia data standards may be included in an overlapped manner in the hardware codec and the software codec.

The digital data output from the ODD may be raw data.

The ODD may directly output the digital data output from the optical disc.

In another aspect, there is provided a smart television (TV). The smart TV includes an ODD that outputs digital data obtained from an optical disc, a digital AV signal processing device that processes an image signal and an audio signal by processing the digital data output from the optical disc transmitted through a predetermined interface, and comprises at least one of a software codec and a hardware codec, a software part that comprises the software codec, and a software graphical user interface by which the ODD is controlled, a display unit and audio output device that outputs the image signal and the audio signal processed by the digital AV signal processing device, and system hardware that is based on an OS and provides an operating environment for the software part and the ODD.

The software part may include a VM that reproduces contents between different OS environments.

The system hardware may include a memory that stores software for the graphical user interface and the software codec of the software part.

The memory may be any one of a flash memory and a hard disc drive (HDD). The software may be capable of being updated by information provided from the outside.

The interface may use any one of an SATA, USB, WiFi, and Bluetooth communication standard.

At least one codec of a plurality of codecs corresponding to a plurality of multimedia data standards may be included in the hardware codec, and the remaining codecs of the plurality of codecs may be included in the software codec.

A plurality of codecs corresponding to a plurality of multimedia data standards may be included in only the hardware codec.

A plurality of codecs corresponding to a plurality of multimedia data standards may be included in only the software codec.

Some or all of a plurality of codecs corresponding to a plurality of multimedia data standards may be included in an overlapped manner in the hardware codec and the software codec.

In another aspect, there is included an electronic device. The electronic device may include a media reading unit that obtains digital data from a storage medium and outputs such digital data so as to be substantially unprocessed raw data, a digital signal processing device comprising a codec device that processes the digital data from the media reading unit and processes a multimedia signal, and a multimedia output device that outputs the multimedia signal processed by the digital signal processing device.

The electronic device may be a smart TV.

Other features and aspects may be apparent from the following detailed description, the drawings, and the claims.

### BRIEF DESCRIPTION OF THE DRAWINGS

FIG. 1 is a diagram that illustrates an example of the basic concept of an audio visual (AV) device.

FIG. 2 is a diagram that illustrates an example of an optical disc drive (ODD) of the AV system of FIG. 1.

FIG. 3 is a block diagram that illustrates an example of a smart television (TV).

FIG. 4 is a diagram that illustrates an example of an architecture of the smart TV.

FIG. 5 is a diagram that illustrates an example of an architecture of the smart TV including an optical disc player, for example, a blu-ray disc-read only memory (BD-ROM) player.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

An optical disc drive (ODD) is a good content source that may further improve the function of such a smart TV.

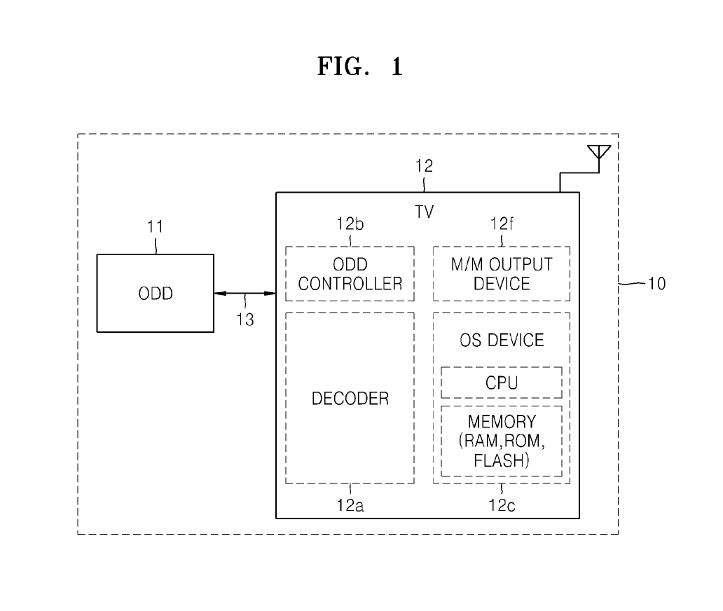

FIG. 1 is a block diagram that illustrates an example of a basic concept of an audio visual (AV) system 10 that is a multimedia system. An AV device refers to a platform-based device that includes a central processing unit (CPU) and an operating system (OS), which may be incorporated into a multimedia system. As an example, an AV device may be a set-top box or a smart television (TV). The AV system 10 using a smart television TV will be explained herein below.

Referring to FIG. 1, the AV system 10 includes an optical disc drive (ODD) 11 and a smart TV 12 on which sky wave, cable broadcasting programs, or other signals input to the smart TV, may be watched.

The ODD 11 is operatively connected to the smart TV 12 through an interface device 13. The smart TV 12 includes a decoder or a codec device 12a that decodes digital data that is output from the ODD 11. The digital data decoded by the codec device 12a may be, for example, raw data or data that has been processed by another device. The smart TV also includes an ODD controller 12b that controls the ODD 11, and an OS device 12c that provides an operating environment in which the codec device 12a and the ODD controller 12b operate. The smart TV includes a multimedia (M/M) output device 12f that includes a display unit and a speaker system for outputting at least one of an image signal and an audio signal. The OS device 12c includes a CPU and at least one memory device. As a non-limiting example, the memory device may include a boot-read only memory (ROM), a random access memory (RAM), and a memory for storing a software codec or a graphical user interface (GUI), for example, a flash memory or a hard disc drive (HDD). The interface device 13 includes at least two operatively connected terminals (or connection devices) that are adapted to transmit and receive data. The terminal at the ODD side is called a slave interface 13a and a terminal at the smart TV side is called a master interface 13b.

For example, according to the example illustrated in FIG. 1, the ODD 11 that provides digital data such as raw data to the smart TV 12 is driven by the ODD controller 12b driven on the OS device 12c using the CPU of the smart TV 12.

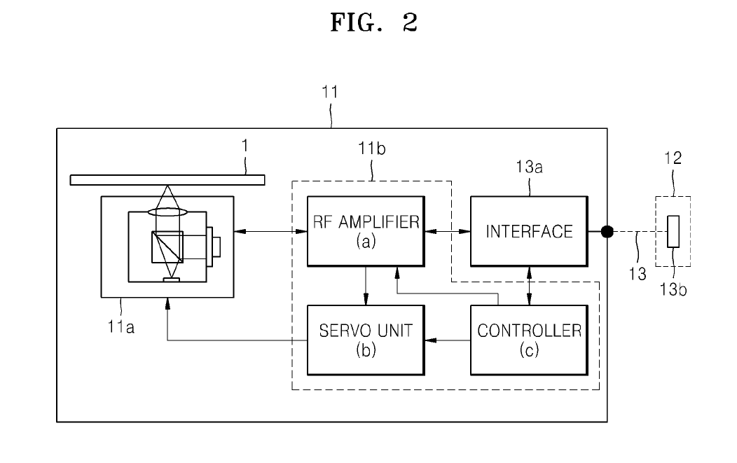

FIG. 2 is a block diagram illustrating an example of the ODD 11 of the AV system 10 of FIG. 1. As shown in FIG. 2, the ODD 11 of the AV system 10 (i.e., as illustrated, for example, in FIG. 1) may include an optical pickup 11a communicating or otherwise reading information from a medium 1. The medium 1 may be, for example, a disc. The ODD 11 may also include a front-end system 11b, and an interface device 13a that is operatively connected to the front-end system 11b. The front-end system 11b may include an RF amplifier ‘a’ that amplifies or otherwise processes a signal output from the optical pickup 11a, a servo unit ‘b’ that controls a tracking and focusing mechanism of the optical pickup 11a, and an optical pickup controller ‘c’ that controls the RF amplifier ‘a’ and the servo unit ‘b’. In contrast, to a conventional ODD, the ODD 11 does not include a back-end system. The front-end system 11b may also include a current/voltage amplifier provided at a front-end of the RF amplifier ‘a’. As an example, the RF amplifier ‘a’ outputs a digital signal obtained by amplifying a high frequency signal to a master device such as the smart TV 12 or the like through the slave interface 13a. In other words, for example, the RF amplifier ‘a’ may process a signal received from the optical pickup 11a. Such processing may include amplifying a high frequency signal. The RF amplifier may then communicate the digital signal to the master device. The slave interface 13a is used to not only output a high frequency signal but also to receive an ODD control signal output from the master device. For example the slave interface 13a may receive an ODD control signal output from the master device and transit such ODD control signal to the optical pickup controller ‘c’. The master device communicating an ODD control signal to the slave interface 13a may be, for example, a smart TV.

As a non-limiting example, interface standards by which the interface device may operate include USB and SATA. Accordingly, the slave interface 13a at the ODD side and the master interface 13b at the smart TV side may be designed to meet the standard USB or SATA. Also, the slave and master interfaces 13a and 13b may meet various wireless interface standards such as WiFi and Bluetooth. In other words, the optical disc device and the smart TV may communicate by means of a hard electrical connection or through wireless means. The USB, SATA, WiFi, and Bluetooth interface standards are merely examples of standards by which communication may occur.

As described above, the smart TV extracts an image/audio signal (data) by processing digital data that is received through the interface device 13. The image/audio signal may be extracted (decoded) by a digital AV signal processing device which includes a hardcore codec and a software codec. The digital data received through the interface device 13 may be raw data. The image/audio signal is output through at least one of the display unit and the speaker system. A decoder included in the digital AV signal processing device includes codecs that use various standards for encoding and decoding various contents provided on mediums (e.g., in disc forms). As an example the various standards may include MPEG2, H.264, and VC-1.

The standard H.264 which is a digital video codec standard having a very high data compression ratio which is called MPEG4 part 10, or advanced video coding (AVC). The standard H.264 is a product of a partnership effort that is known as the joint video team (JVT) by the ITU-T video coding experts group (VCEG) together with the ISO/IEC moving picture experts group (MPEG). Hence, the standard ITU-T H.264 and the standard ISO/IEC MPEG4 part 10 (formally, ISO/IEC 14496-10) have identical technical content. The standard H.264/AVC has been developed to provide good video quality at substantially lower bit rates than previous standards such as MPEG2, H.263, and MPEG4 Part 2. After the standard H.264/AVC was completed in 2003, in the first project to extend the standard H.264, the JVT developed what was called the fidelity range extensions (FRExt) (version 7 of 2007). These extensions enabled higher quality video coding by supporting increased sample bit depth precision and higher resolution color information, including sampling structures known as YUV 4:2:2 and YUV 4:4:4. Also, a scalable video coding (SVC) mode (version 8 of 2007) was additionally supported, and a multiview video coding (MVC) that may use multiple cameras was added in 2009.

Medium 1 may be a blu-ray disc (BD) used for providing various contents. For example, a BD is an optical storage medium developed by the Blu-ray disc association (BDA) led by Sony to store data such as high-definition (HD) video. Because such a BD uses a laser having a wavelength of 405 nanometers (nm) which is much shorter than that of a digital versatile disc (DVD) in order to read stored data, the BD may store more data than a DVD despite a BD having the same size as a DVD. For example, a BD having a diameter of 12 cm and including a single layer recording surface is capable of storing 25 gigabyte (GB) data, and a BD with dual layer discs is capable of storing 50 GB data. Such a BD may be modified into a BD for storing computer data (BD-ROM), a recordable BD (BD-R), a rewritable BD (BD-RE). Various copy prevention technologies for preventing illegal reproduction of video data stored in a BD have been developed. Because such copy prevention technologies may be differently used according to discs, even though a copy prevention technology for one disc is invalid, access to copy prevention technologies for other discs may not be permitted. Also, because BD-ROM manufacturers may be easily identified by using a water marking technology, an unauthenticated company may be prevented from manufacturing discs without permission.

Accordingly, the ODD 11 may be an ODD that drives and reads and/or writes a BD. An ODD may be designed to be compatible with existing media formats. For example, an ODD may be designed so as to be compatible with compact discs (CDs) or DVDs. The ODD 11 may also be compatible with CDs, DVDs, and BDs.

A codec compresses audio and image data. The performance of a codec depends on several factors including the amount of time the codec performs reproduction, the resolution at which the codec compresses the audio and/or image data, and the amount of storage space in which the compressed audio and/or image data may be required to fit. A codec may be classified into a lossy codec and a lossless codec. All ODDs may support codecs using standards such as MPEG2, H.264/AVC, and SMPTE VC-1. For example, a codec using MPEG2 is used in a DVD, and is compatible with other versions. A codec using H.264/AVC has been developed as a codec using a subsequent version of MPEG4 by the MPEG and the VCEG. A codec using VC-1 is a derivative codec developed under the leadership of Microsoft. A medium 1 such as a BD-ROM that stores image and audio data may use one of the above three codecs. A plurality of codecs may be simultaneously put into one title (content).

For example, the AV system 10 of FIG. 1 may include all or some of the above identified codecs. The AV system 10 may include codecs for BDs. Further, for greater compatibility, the AV system 10 may include codecs corresponding to both DVDs and BDs. Codecs may be supported by a hardware codec, for example through a multi-functional codec (MFC) chip, and a software codec. For example, some codecs may be supported by a hardware codec such as an MFC chip, and the remaining codecs may be supported by a software codec loaded on an storage medium (e.g., RAM). Codecs supported in software forms may be registered and updated in a storage device of the AV system 10. For example, the storage device of the AV system may be an HDD or a flash memory. The software codec may be registered and updated using a program installation process. For example, if the software codec is used, then a load on the system hardware that provides the basic function of exploring an OS of the OS device 12C may be used. In addition, the smart TV may update the codecs by means of communicating with various data servers over the Internet. For example, the OS device 12 may automatically search for new or updated codecs available. The OS device 12 may search for the new or updated codecs based on a predetermined condition such as powering on of the smart TV or use of the ODD. Alternatively, the OS device 12 may search for the new or updated codecs based on a predetermined schedule, such as on a daily, weekly, monthly, etc. basis. As an example, at least one of the plurality of codecs corresponding to a plurality of multimedia data standards may be included in an overlapped manner in the hardware codec and the software codec. As an example, all codecs may be included in an overlapped manner in the hardware codec and/or the software codec. Alternatively, as an example, all codecs may be supported by only the software codec. Alternatively, as an example, all codecs may be supported by only the hardware codec.

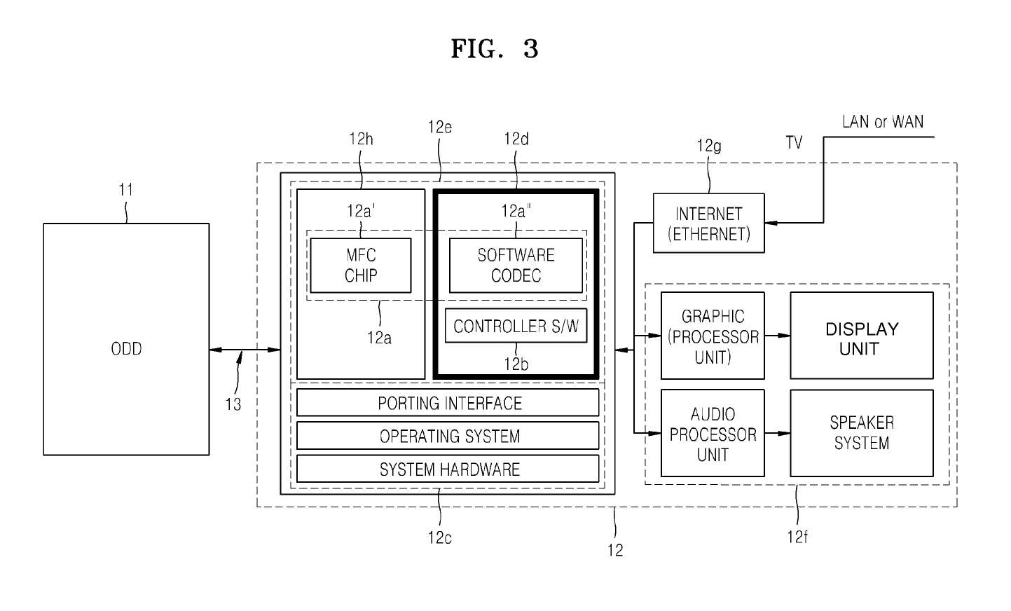

FIG. 3 is a diagram illustrating an example of a smart TV 12 of the AV system 10 of FIG. 1.

The smart TV 12 may be connected to the ODD 11 through the interface device 13 using a wireless communication standard such as, for example, WiFi or Bluetooth or a wired communication standard such as, for example, USB or SATA. The smart TV 12, which includes a computer structure corresponding to the OS device 12c, further include a digital multimedia signal processing device 12e that processes a digital signal such as raw data. The digital multimedia signal processing device may also process pre-processed data. The digital multimedia signal processing device 12e may include a hardware part 12h that has an MFC chip 12a′ corresponding to a hardware codec. The digital multimedia signal processing device 12e may also include a software part 12d. The software part 12d may include a software codec 12a″, and an ODD controller 12b that corresponds to a GUI.

Because the software part 12d includes the ODD controller 12b that is software, and the software codec 12a″, the codec device 12a of FIG. 3 may have a software/hardware-based codec mechanism using the MFC chip 12A′, which is a hardware codec, and the software codec 12a″.

As an example, the digital multimedia signal processing device 12e may include only one of the MFC chip 12a′ and the software codec 12a″. Thus, all codecs may be supported by only the MFC chip 12a′ or the software codec 12a″. In other words, if the digital multimedia signal processing device 12e includes only the hardware codec (e.g., the MFC chip 12a′), then the hardware codec may support all codecs. Additionally, if the digital multimedia signal processing device 12e includes only the software codec 12a″, then the software codec may support all codecs.

However, if the digital multimedia signal processing device 12e includes both hardware codecs (e.g., the MFC chip 12a′) and software codecs 12a″, then each of the hardware codecs and software codecs may support all codecs or a subset of all codecs. As an example, when the codecs supported by the hardware codecs are combined with the codecs supported by the software codecs, all codecs may be supported.

The OS device 12c includes system hardware, an OS loaded on the system hardware, and a porting interface loaded on the OS. The system hardware may include a CPU and at least one memory device. For example, the memory device may include a non-volatile memory device such as a RAM, a flash memory (media), an HDD, or the like.

The digital multimedia signal processing device 12e for processing a digital AV signal may include a hardware part 12h and a software part 12d. The hardware part 12h may include the MFC chip 12a′, and the software part 12d may include the ODD controller 12b, and the software codec 12a″. As an example, the ODD controller 12b may be a GUI by which a user interacts with the digital multimedia signal processing device 12e. As an example, the software codec 12 a″ processes digital data and processes a multimedia signal such as an audio signal and/or an image signal.

The software part 12d including the software codec 12a″ may be stored in a program storage device that is included in the system hardware 12c of the smart TV 12. The program storage device may be an HDD, a flash memory, or the like. The software part 12d is activated by being loaded on the system hardware 12c memory (e.g., RAM) under the control of the OS.

The smart TV 12 may include a networking device. For example, the smart TV 12 may include an Internet device 12g. The internet device 12g may be based on the Ethernet. Further, the networking device may be a separate source supply. Due to the Internet device 12g, IPTV or Internet information may be accessed. Also, the smart TV 12 may include an M/M output device 12f that includes a display unit. The display unit may be an LCD, LED, plasma, or the like. The smart TV 12 may also include a graphic processor unit that drives the display unit, a speaker system that receives an audio signal and that converts a radio frequency into an audio frequency, and an audio processor unit that electrically drives the speaker system. For example, the graphic processor unit may process a 2D image and/or a 3D image, and the display unit may correspondingly display the 2D image and/or the 3D image.

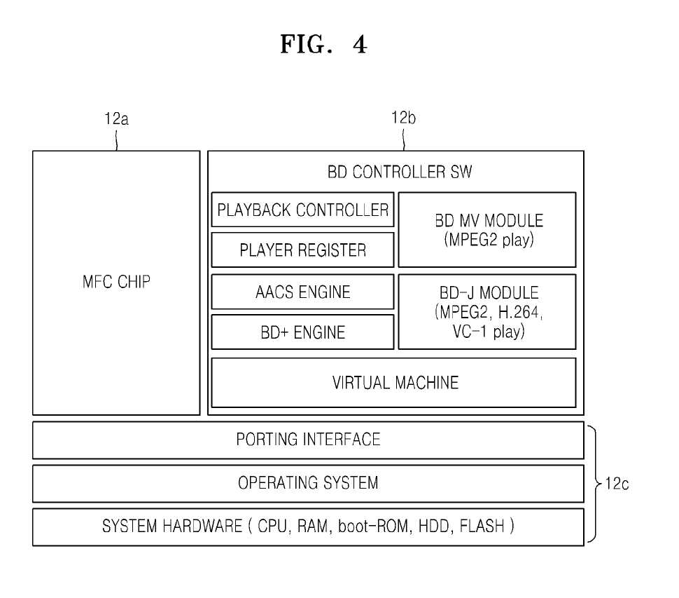

FIG. 4 illustrates an example of an architecture of the smart TV 12. For example, the smart TV may include an OS device having system hardware that includes at least one of a RAM, a ROM (e.g., boot ROM), an HDD, a flash memory, or the like. The smart TV may also include a CPU such as x86, ARM, MIPS developed by Intel, or the like may be mounted in the form of system-on-chip (SoC). The OS mounted on the system hardware may be any one of an open source OS such as Android, iOS of Apple, bada developed by Samsung, Linux which is an open OS, or the like. The software part 12d may include a virtual machine (VM). For example, if an OS of contents provided from the ODD 11 is different from the OS of the smart TV 12, then the VM ports the contents. Similarly, if the OS of contents provided from the OS of the smart TV 12 is different from the ODD 11, then the VM ports the contents. For example, the VM may be a VM that supports Java, Dalvik, bada, or Linux. The ODD controller 12b of the software part 12d may include a playback controller, and a register that stores ODD information. If the ODD 11 is an ODD for BDs, the ODD controller 12b may further include an advanced access contents system (AACS) engine for copy prevention, a BD+ engine that is a BD rights management system, a BD MV module for MPEG2, and a BD-J module that reproduces MPEG2, H.264, and VC-1.

The hardware codec (e.g., the MFC chip 12a′) which is driven by the OS device 12c may support MPEG2, MPEG4, H.264, and VC-1 for reproducing contents for BDs. For example, codecs not supported by the MFC chip 12a′ may be supported by the software codec 12a″ included in the software part 12d as described above. Alternatively, all codecs may be supported by hardware codec (e.g., the MFC chip 12a′). Alternatively, as an example, the hardware part 12h may not include a hardware codec (e.g., the MFC chip 12a′). Consequently, the software part 12 may support all codecs.

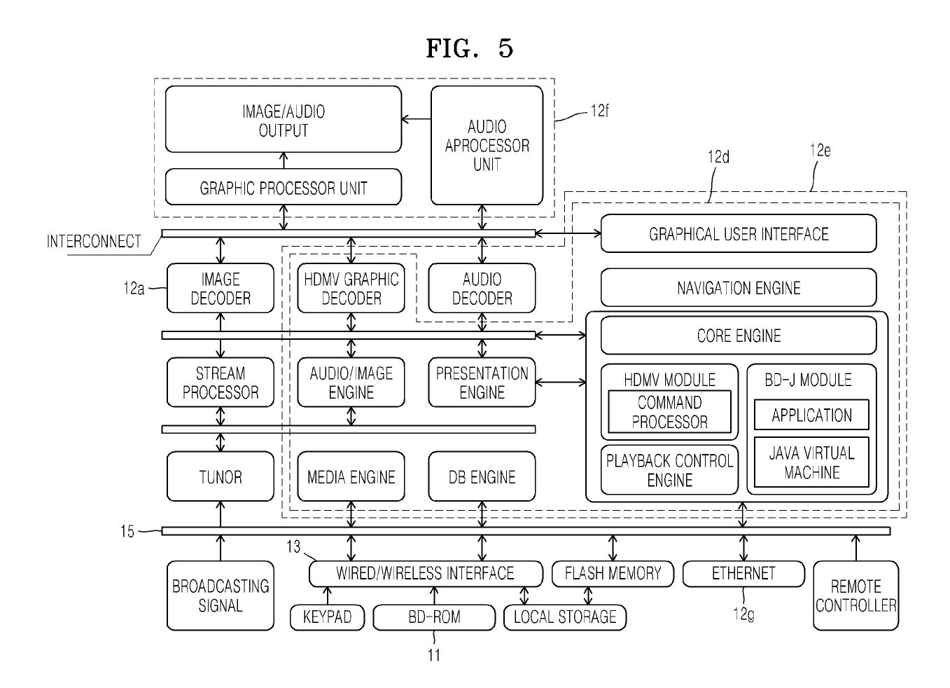

FIG. 5 illustrates an example of an architecture of the smart TV 12 that includes, for example, a BD-ROM player as the ODD 11. As illustrated in FIG. 5, hardware and software transmit and receive data therebetween through a plurality of interconnectors. Each of the plurality of interconnectors is illustrated in FIG. 5 as narrow long lines that are arranged in a horizontal direction.

As an example, the smart TV 12 of the AV system 10 may include an OS device 12c that includes a graphic processor (GPU), a CPU, a system timer, a boot ROM, and a RAM. Image/audio sources such as a BD-ROM and a local storage may be connected to a source interconnector 15 through the interface device 13 using a communication standard such as USB, SATA, WiFi, or Bluetooth. Also, a broadcasting signal, a remote controller, and the Ethernet may be connected to the source interconnector 15.

A broadcasting signal passes through a tuner (e.g., a TV tuner, or a DTV tuner), a stream processor, and the like. The signal is processed and an image signal and/or an audio signal are reproduced in a video decoder and an audio decoder. The video decoder may be supported by the hardware codec. A medium such as a BD-ROM may store digital data, such as raw data. The to the AV system 10 may read such digital data. For example, an ODD may read the digital data and provide the digital data through the interface device 13 using a communication standard. For example, the communication standard may be USB, SATA, WiFi, or Bluetooth. A reproduction device that is a BD-ROM application environment for reproducing raw data is supported by the software part 12d, and may include a high-definition movie mode (HDMV) module and/or a BD-J module.

For example, the HDMV module may include a command processor. The BD-J module may include a Java VM and an application manager. The HDMV module is applied to a high resolution movie using MPEG2. The BD-J module may support bonus contents of a BD supporting a Java media engine (ME) in an interactive manner. In other words, the BD-J module may support bonus contents of a BD so as to allow a user to interact with such bonus contents. The BD-ROM player supported by a BD-ROM environment through a function and an application programming interface (API) may include a playback control engine, a presentation engine, and the like. For example, the playback control engine may reproduce/manage a specific stream, and the presentation engine may display the specific stream on the displayer.

A DB engine controls data to be generated, managed, and invoked. A media engine (ME) performs media-related various functions. For example, the ME controls the BD-ROM and the local storage unit (e.g., an external HDD or a flash memory connected through the interface device 13 using a communication standard such as SATA, USB, or Bluetooth), searches a network or the like, and manages media. For example, the ME for BDs and DVDs may be a basic engine that enables the BDs and DVDs to be accessed in order to perform functions such as reading data. For example, during BD or DVD playback, if information is provided through a navigation stream that is an interactive stream between a user and the presentation engine, the presentation engine may provide a subtitle stream and a multiplex including video and audio based on user input. For example, a user may enter user input using various buttons of a viewer press remote controller. A navigation engine may determine which contents are to be reproduced next time and sends a result of the determination to the presentation engine.

A codec is included in a platform-based AV device such as a TV or a set-top box is used. In other words, in an aspect, an ODD does not include a separate codec. The ODD directly transmits digital data obtained from a medium (e.g., a disc) to the AV device. The digital data obtained from the medium may be for example, raw data. The AV device controls the ODD by using an ODD controller included in the AV device, and reproduces or extracts a multimedia signal such as image/audio data by using a digital AV signal processing device that stores the raw data obtained from the ODD. Accordingly, the ODD may include a separate mechanical device and an interface device that controls the mechanical device and that transmits digital data (e.g., raw data). According to an aspect, the ODD does not include, for example, a back-end part including a hardware decoder. Consequently, manufacturing costs are reduced.

As an example, the AV device may register and update a GUI and a software codec by using the ODD, an HDD, a flash memory, or the like, and may flexibly respond to any new GUI or codec. Also, because raw data that is digital data obtained from the ODD may be directly produced by using the digital AV signal processing device, an increase in costs due to removing a back-end part from the ODD is not high. According to an aspect, because the ODD provides pure raw data, hardware porting or software porting for maintaining compatibility with the AV device such as a TV or a set-top box is not required.

According to the examples described above, a multimedia system that may economically and efficiently use an optical disc drive (ODD) may be provided. The units described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement function A, and a second processor configured to implement functions B and C, a first processor configured to implement functions A, B, C, and a second processor configured to implement functions A, B, and C, and so on.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The computer readable recording medium may include any data storage device that can store data which can be thereafter read by a computer system or processing device. Examples of the computer readable recording medium include read-only memory (ROM), random-access memory (RAM), CD-ROMs, magnetic tapes, floppy disks, optical data storage devices. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multimedia system comprising:
an optical disc drive (ODD) which outputs digital data obtained from an optical disc;
a digital signal processing device comprising a codec device which processes the digital data from the optical disc and processes a multimedia signal; and
a multimedia output device which outputs the multimedia signal processed by the digital signal processing device.

2. The multimedia system of claim 1, wherein the codec device comprises at least one of a hardware codec and a software codec corresponding to a plurality of multimedia data standards.

3. The multimedia system of claim 2, further comprising:
an operating system (OS) device comprising an OS which provides an operating environment for the at least one codec, and
a processing unit which drives the OS.

4. The multimedia system of claim 2, further comprising a graphical user interface by which the ODD is controlled,
wherein the software codec has a structure which is capable of being updated by information provided from an external storage device.

5. The multimedia system of claim 1, further comprising a plurality of interface devices which transmit and receive data to and from a plurality of source devices.

6. The multimedia system of claim 5, wherein at least one of the plurality of interface devices communicates using at least one of the universal serial bus (USB), serial advanced technology attachment (SATA), flash media, Ethernet, WiFi, and Bluetooth communication standards.

7. The multimedia system of claim 5, further comprising a stream processor which processes a video data stream.

8. The multimedia system of claim 7, wherein the video data stream is provided through a wired device or a wireless device.

9. The multimedia system of claim 3, further comprising a stream processor which processes a video data stream provided through the Ethernet.

10. The multimedia system of claim 3, further comprising a software controller which controls the ODD,
wherein the software controller is capable of being updated by information provided from an external storage device.

11. The multimedia system of claim 10, wherein the software controller comprises the software codec.

12. The multimedia system of claim 10, further comprising a virtual machine (VM) which drives a source device that operates on an OS different from the OS of the OS device.

13. The multimedia system of claim 12, wherein the VM comprises a Java VM or a Dalvik VM corresponding to at least one of a Java and an Android source device.

14. The multimedia system of claim 2, wherein at least one codec of a plurality of codecs corresponding to the plurality of multimedia data standards is included in the hardware codec and the remaining codecs of the plurality of codecs is included in the software codec.

15. The multimedia system of claim 2, wherein a plurality of codecs corresponding to the plurality of multimedia data standards are included in only the hardware codec.

16. The multimedia system of claim 2, wherein a plurality of codecs corresponding to the plurality of multimedia data standards are included in only the software codec.

17. The multimedia system of claim 2, wherein some or all of a plurality of codecs corresponding to the plurality of multimedia data standards are included in an overlapped manner in the hardware codec and the software codec.

18. The multimedia system of claim 1, wherein the digital data output from the ODD is raw data.

19. The multimedia system of claim 1, wherein the ODD directly outputs the digital data output from the optical disc.

20. A smart television (TV) comprising:
an ODD which outputs digital data obtained from an optical disc;
a digital AV signal processing device which processes an image signal and an audio signal by processing the digital data output from the optical disc transmitted through a predetermined interface, and comprises at least one of a software codec and a hardware codec;
a software part which comprises the software codec, and a software graphical user interface by which the ODD is controlled;
a display unit and audio output device which outputs the image signal and the audio signal processed by the digital AV signal processing device; and
system hardware which is based on an OS and provides an operating environment for the software part and the ODD.

21. The smart TV of claim 20, wherein the software part further comprises a VM which reproduces contents between different OS environments.

22. The smart TV of claim 20, wherein the system hardware further comprises a memory which stores software for the graphical user interface and the software codec of the software part.

23. The smart TV of claim 22, wherein the memory is any one of a flash memory and a hard disc drive (HDD).

24. The smart TV of claim 22, wherein the software is capable of being updated by information provided from the outside.

25. The smart TV of claim 20, wherein the interface uses any one of an SATA, USB, WiFi, and Bluetooth communication standard.

26. The smart TV of claim 20, wherein at least one codec of a plurality of codecs corresponding to a plurality of multimedia data standards are included in the hardware codec, and the remaining codecs of the plurality of codecs are included in the software codec.

27. The smart TV of claim 20, wherein a plurality of codecs corresponding to a plurality of multimedia data standards are included in only the hardware codec.

28. The smart TV of claim 20, wherein a plurality of codecs corresponding to a plurality of multimedia data standards are included in only the software codec.

29. The smart TV of claim 20, wherein some or all of a plurality of codecs corresponding to a plurality of multimedia data standards are included in an overlapped manner in the hardware codec and the software codec.

30. An electronic device, the electronic device comprising:
a media reading unit which obtains digital data from a storage medium and outputs such digital data so as to be substantially unprocessed raw data;
a digital signal processing device comprising a codec device which processes the digital data from the media reading unit and processes a multimedia signal; and
a multimedia output device which outputs the multimedia signal processed by the digital signal processing device.

31. The electronic device of claim 30, wherein the electronic device is a smart TV.
